(19) United States
(12) Patent Application Publication
(10) Pub. No.: US 2014/0240499 A1
(43) Pub. Date: Aug. 28, 2014

(54) FRONT-AND-REAR-FACING CAMERA DEVICE

(71) Applicant: CANSONIC INC., New Taipei City (TW)

(72) Inventor: Chao-Chih HSU, New Taipei City (TW)

(73) Assignee: CANSONIC INC., New Taipei City (TW)

(21) Appl. No.: 14/184,953

(22) Filed: Feb. 20, 2014

(30) Foreign Application Priority Data
Feb. 26, 2013 (TW) 102203586

(51) Int. Cl. H04N 5/225

(52) U.S. Cl. CPC H04N 5/2254
USPC 348/148

(57) ABSTRACT

A front-and-rear-facing camera device has a camera unit mounted on a selected position on a carrier. The camera unit has a front lens and a rear lens oppositely mounted on a lens-mounting base to take a front-view video stream and a rear-view video stream, and displays the front-view and rear-view video streams on two non-overlapping display areas of a display, or displays the front-view video stream on an overlapping display area of the display and the rear-view video stream on the displayed front-view video stream through an image-processing circuit and a signal transmission interface electrically connected between the front and rear lenses and the display.

### BACKGROUND OF THE INVENTION

1. Field of the Invention

The present invention relates to a camera device, and more particularly to a front-and-rear facing camera device capable of taking a front-view video stream and a rear-view video stream at the same time.

2. Description of the Related Art

Upon cycling, skateboarding, rowing boat or canoe or the like, people rarely know if they exercise in a right way and how their exercising postures should be improved. Camera devices are one kind of tools that are brought into play for tracking every move of people made in those exercising activities.

Further, to ensure driving safety and keep effective evidence for clarifying traffic accident liability, more and more vehicle drivers and motorcyclists equip their vehicles and motorcycles with car recorders to record traffic conditions in the front.

However, the foregoing camera devices used in exercising and the car recorders are generally equipped with a single lens and thus can only take a video stream within limited ranges and view angles. Besides, the camera devices and the car recorders can only take either front-view scenery or rear-view self portrait of the exercising person or the motorist while failing to take the views from both directions.

### SUMMARY OF THE INVENTION

An objective of the present invention is to provide a front-and-rear-facing camera device capable of simultaneously taking a front-view video stream and a rear-view video stream.

To achieve the foregoing objective, the front-and-rear-facing camera device has a carrier and a camera unit.

The camera unit is mounted on a selected position on the carrier and has a lens-mounting base, a front lens, a rear lens, an image-processing circuit, a signal transmission interface and a display.

The lens-mounting base has a base-mounting surface, a front lens-mounting surface, and a rear lens-mounting surface.

The base-mounting surface is affixed on the selected position on the carrier. The front lens-mounting surface and the rear lens-mounting surface are formed on two opposite sides of the lens-mounting base.

The front lens is mounted on the front lens-mounting surface, has a front shooting angle, and takes a front-view video stream of a surrounding environment within a range of the front shooting angle.

The rear lens is mounted on the rear lens-mounting surface, has a rear shooting angle, and takes a rear-view video stream of the surrounding environment within a range of the rear shooting angle.

The image-processing circuit is electrically connected to the front lens and the rear lens to receive the front-view video stream and the rear-view video stream.

The signal transmission interface is electrically connected to the image-processing circuit.

The display is electrically connected to the image-processing circuit through the signal transmission interface to receive the front-view video stream and the rear-view video stream transmitted from the image-processing circuit and to display the front-view video stream and the rear-view video stream on the display.

Given the technical measure of the present invention, users can record a front-view video stream and a rear-view video stream at the same time using the front-and-rear-facing camera device and enjoy the fun of watching the scenery in the front and the image of themselves on a display of the front-and-rear-facing camera device during exercise. When the front-and-rear-facing camera device is mounted on a vehicle, users can simultaneously see traffic conditions in front of and behind the vehicle as references to users' driving on the road.

Other objectives, advantages and novel features of the invention will become more apparent from the following detailed description when taken in conjunction with the accompanying drawings.

### BRIEF DESCRIPTION OF THE DRAWINGS

FIG. 1 is schematic cross-sectional view of a front-and-rear-facing camera device in accordance with the present invention;

FIG. 2 is a functional block diagram of the front-and-rear-facing camera device in FIG. 1;

FIG. 3 is a functional block diagram of the front-and-rear-facing camera device in FIG. 1 with a wireless communication interface connected between a display and an image processing circuit in FIG. 2;

FIG. 4 is a schematic view of the front-and-rear-facing camera device in FIG. 1 mounted on a bicycle;

FIG. 5 is a schematic view of a display of the front-and-rear-facing camera device in FIG. 1;

FIG. 6 is a schematic view of another display of the front-and-rear-facing camera device in FIG. 1; and

FIG. 7 is a schematic view of the front-and-rear-facing camera device in FIG. 1 mounted on a skateboard.

### DETAILED DESCRIPTION OF THE INVENTION

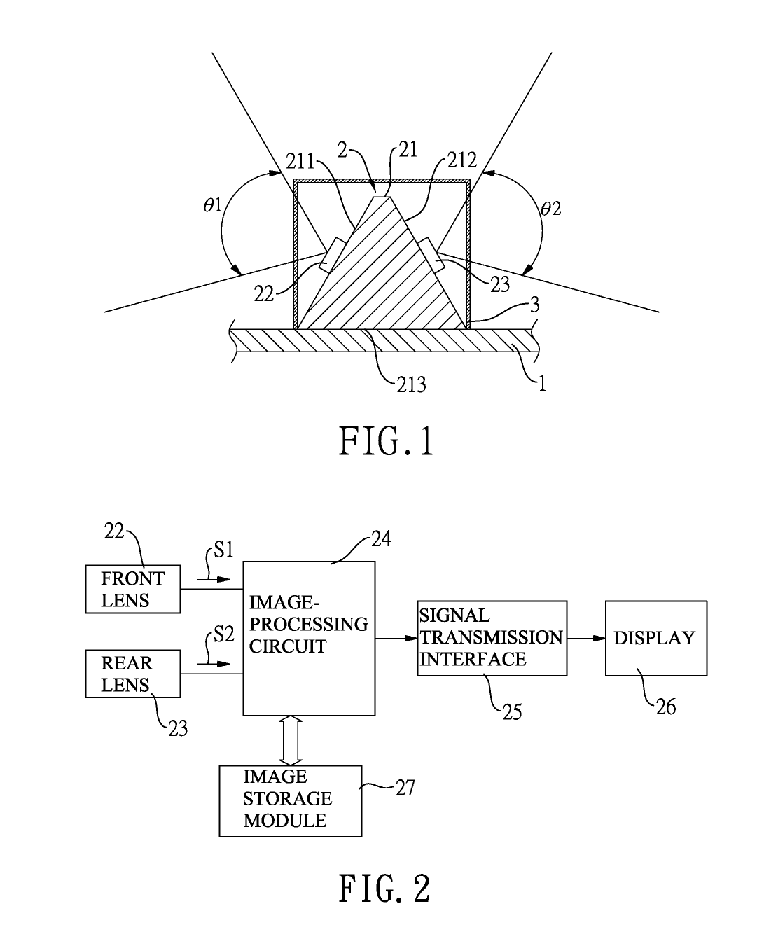

With reference to FIGS. 1 and 2, a front-and-rear-facing camera device in accordance with the present invention has a carrier 1, a camera unit 2 and a waterproof cover 3. Optionally, the front-and-rear-facing camera device may have an image storage module 27.

In practical applications the carrier 1 may be a deck of a skateboard, a handle bar of a bicycle or a motorcycle, or a dashboard of a vehicle. The camera unit 2 takes the form of a sphere, a cube, a polyhedron or the like, and has a lens-mounting base 21, a front lens 22, a rear lens 23, an image-processing circuit 24, a signal transmission interface 25, and a display 26.

The lens-mounting base 21 has a front lens-mounting surface 211, a rear lens-mounting surface 212 and a base-mounting surface 213. The base-mounting surface 213 is affixed on a selected position on the carrier 1. The front lens-mounting surface 211 and the rear lens-mounting surface 212 are formed on two opposite sides of the lens-mounting base 21. The front lens 22 is mounted on the front lens-mounting surface 211, has a front shooting angle 01, and takes a front-view video stream S1 of a surrounding environment within a range of the front shooting angle θ1. The rear lens 23 is mounted on the rear lens-mounting surface 212, has a rear shooting angle θ2, and takes a rear-view video stream S2 of the surrounding environment within a range of the rear shooting angle θ2. The front shooting angle θ1 and the rear shooting angle θ2 are adjustable. The image-processing circuit 24 is electrically connected to the front lens 22 and the rear lens 23 to receive the front-view video stream Si and the rear-view video stream S2.

The signal transmission interface 25 is electrically connected to the image-processing circuit 24. The signal transmission interface 25 may be a wired signal transmission interface, such as an electrical wire.

The display 26 is electrically connected to the image-processing circuit 24 through the signal transmission interface 25 to receive the front-view video stream S1 and the rear-view video stream S2 transmitted from the image-processing circuit 24 and to display the front-view video stream Si and the rear-view video stream S2 on the display 26.

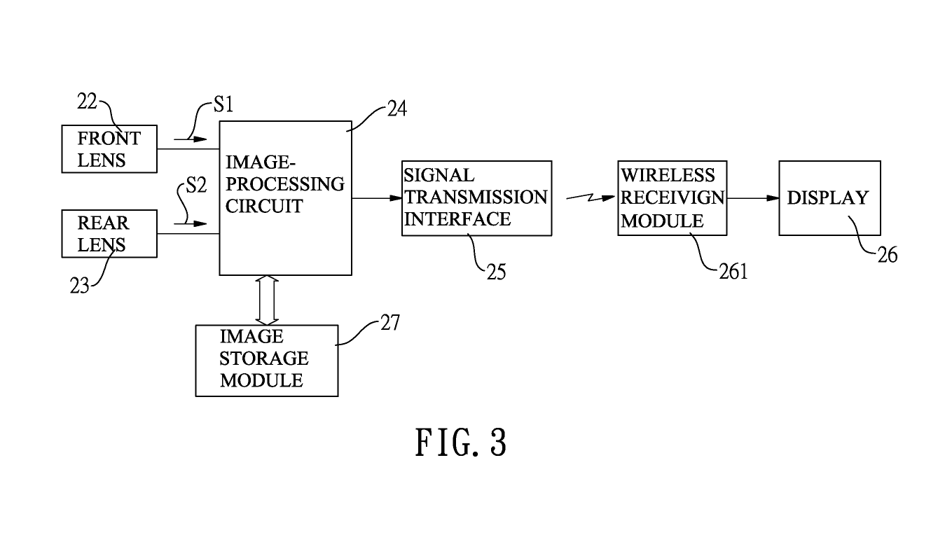

With reference to FIG. 3, the signal transmission interface is a wireless signal transmission interface 25a, and the display 26 displays the front-view video stream S1 and the rear-view video stream S2, which are wirelessly transmitted to the display 26 through the wireless signal transmission interface 25a and a wireless receiving module 261 of the display 26.

The waterproof cover 3 covers the front lens 22 and the rear lens 23 to avoid damage arising from water permeating into the front lens 22 and the rear lens 23 in the course of video recording.

The image storage module 27 is electrically connected to the image-processing circuit 24 to store the front-view video stream S1 and the rear-view video stream S2.

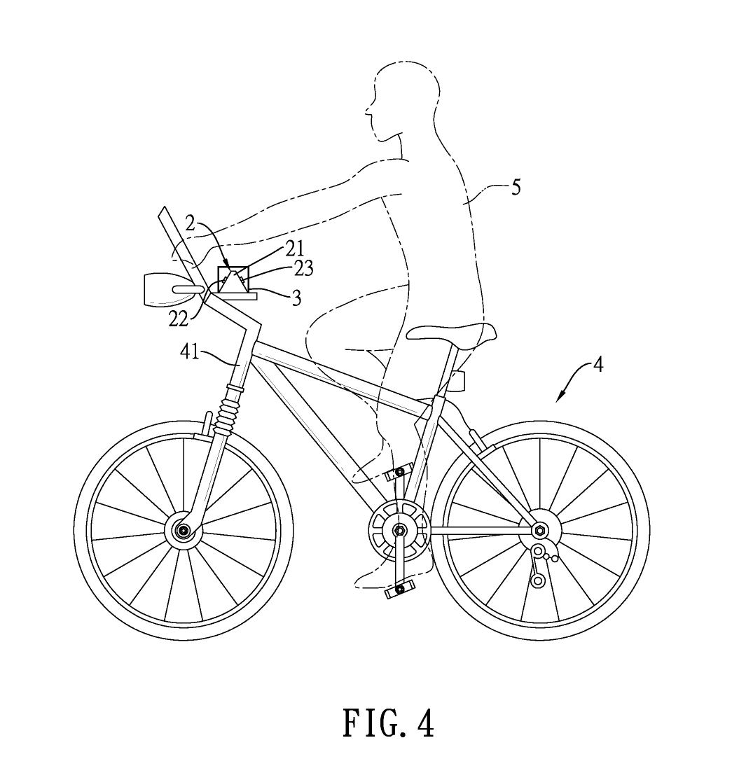

With reference to FIG. 4, when the front-and-rear-facing camera device is mounted on a bicycle 4, the camera unit 2 is mounted on a selected position on a handle bar of the bicycle 4 such that the front lens 22 takes a video of the scenery in the front and the rear lens 23 takes a video of the cyclist during cycling.

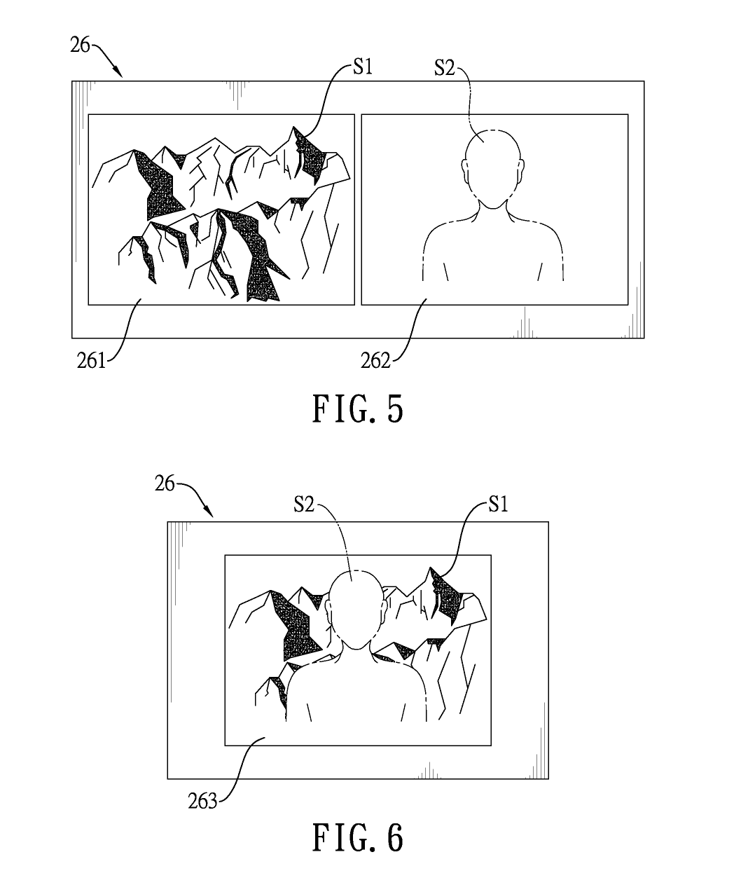

With reference to FIG. 5, the front-view video stream S1 and the rear-view video stream S2 are respectively displayed on two non-overlapping display areas 261, 262 of the display 26. With reference to FIG. 6, the front-view video stream S1 is displayed on an overlapping display area 263 of the display 26 and the rear-view video stream S2 is displayed on the displayed front-view video stream S1.

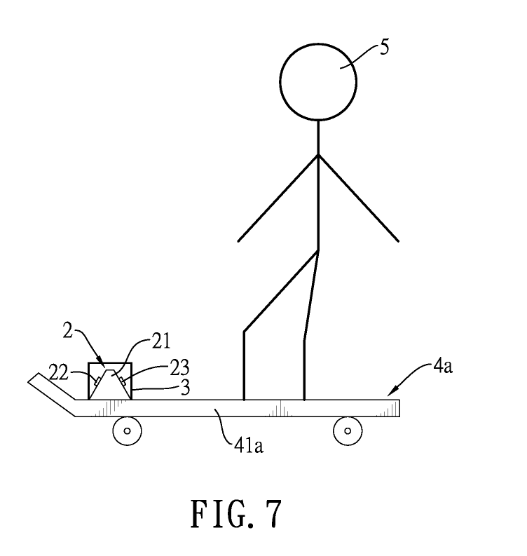

With reference to FIG. 7, when the front-and-rear-facing camera device is mounted on a skateboard 4a, the camera unit 2 is mounted on a selected position on a deck 41a of the skateboard 4a such that the front lens 22 takes a video of the scenery in the front and the rear lens 23 takes a video of the skateboard skater during skateboarding.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A front-and-rear-facing camera device, comprising:
a carrier; and
a camera unit mounted on a selected position on the carrier, and having:
a lens-mounting base having:
a base-mounting surface affixed on the selected position on the carrier; and
a front lens-mounting surface and a rear lens-mounting surface formed on two opposite sides of the lens-mounting base;
a front lens mounted on the front lens-mounting surface, having a front shooting angle, and taking a front-view video stream of a surrounding environment within a range of the front shooting angle;
a rear lens mounted on the rear lens-mounting surface, having a rear shooting angle, and taking a rear-view video stream of the surrounding environment within a range of the rear shooting angle;
an image-processing circuit electrically connected to the front lens and the rear lens to receive the front-view video stream and the rear-view video stream;
a signal transmission interface electrically connected to the image-processing circuit; and
a display electrically connected to the image-processing circuit through the signal transmission interface to receive the front-view video stream and the rear-view video stream transmitted from the image-processing circuit and to display the front-view video stream and the rear-view video stream on the display.

2. The front-and-rear-facing camera device as claimed in claim 1, wherein the signal transmission interface is a wireless signal transmission interface or a wired signal transmission interface.

3. The front-and-rear-facing camera device as claimed in claim 1, wherein the front-view video stream and the rear-view video stream are respectively displayed on two non-overlapping display areas of the display.

4. The front-and-rear-facing camera device as claimed in claim 1, wherein the front-view video stream is displayed on an overlapping display area of the display and the rear-view video stream is displayed on the displayed front-view video stream.

5. The front-and-rear-facing camera device as claimed in claim 1, further comprising a waterproof cover covering the front lens and the rear lens.

6. A front-and-rear-facing camera device, comprising:
a carrier; and
a camera unit mounted on a selected position on the carrier, and having:
a lens-mounting base having:
a base-mounting surface affixed on the selected position on the carrier; and
a front lens-mounting surface and a rear lens-mounting surface formed on two opposite sides of the lens-mounting base;
a front lens mounted on the front lens-mounting surface, having a front shooting angle, and taking a front-view video stream of a surrounding environment within a range of the front shooting angle;
a rear lens mounted on the rear lens-mounting surface, having a rear shooting angle, and taking a rear-view video stream of the surrounding environment within a range of the rear shooting angle;
an image-processing circuit electrically connected to the front lens and the rear lens to receive the front-view video stream and the rear-view video stream; and
an image storage module electrically connected to the image-processing circuit to store the front-view video stream and the rear-view video stream.

7. The front-and-rear-facing camera device as claimed in claim 6, further comprising a waterproof cover covering the front lens and the rear lens.
